(19) United States
(12) Patent Application Publication
(10) Pub. No.: US 2014/0374387 A1
(43) Pub. Date: Dec. 25, 2014

(54) WIRELESS TRANSMISSION IN THE ENVIRONMENT OF A WELDING APPARATUS

(71) Applicant: ROBERT BOSCH GMBH, STUTTGART (DE)

(72) Inventors: Harald Lukosz, Schorndorf (DE); Peter Duerrschmied, Michelstadt (DE)

(21) Appl. No.: 14/294,295

(22) Filed: Jun. 3, 2014

(30) Foreign Application Priority Data
Jun. 20, 2013 (DE) 10 2013 211 638.1
Dec. 17, 2013 (DE) 10 2013 226 146.2

(51) Int. Cl. B23K 9/10; B23K 37/00; B23K 11/24

(52) U.S. Cl. CPC B23K 9/1062; B23K 9/1006; B23K 11/241; B23K 37/00
USPC 219/78.01; 219/136; 219/137 R

(57) ABSTRACT

A welding inverter includes a device for achieving wireless data transmission via radio between the welding inverter and a further device. The device is configured such that wireless and preferably safe communication is configured to be achieved therebetween. The welding inverter is thereby configured to be used flexibly as regards its installation location in the existing infrastructure without being modified.

This application claims priority under 35 U.S.C. §119 to patent application nos. DE 10 2013 211 638.1 filed on Jun. 20, 2013 in Germany and DE 10 2013 226 146.2 filed on Dec. 17, 2013 in Germany, the disclosures of which are incorporated herein by reference in their entirety.

### BACKGROUND

The disclosure relates to a welding apparatus as known from document EP1512483 A1, which discloses an apparatus for resistance welding using a welding system comprising at least: a power supply system, a welding apparatus, a welding process controller, a servo-controlled welding gun and a servo-controlled gun controller, wherein the welding apparatus, the welding process controller, the power supply system and the servo-controlled gun controller form a physical unit.

In order to integrate the welding apparatus into the existing infrastructure, Ethernet connections are normally used, by means of which the Fieldbus protocols which are commonly used in automation engineering can be transmitted between the components. The cabling costs can be very high depending on the complexity of the welding tasks to be performed.

For instance, production lines in the automotive industry can comprise a large number of welding apparatuses such as welding inverters, which need to be parameterized, operated and maintained, and the behavior of which needs to be logged and analyzed diagnostically.

The object of the disclosure is therefore to reduce the necessary cabling costs and to increase the flexibility when using the welding apparatuses and the operating equipment thereof.

### SUMMARY

The disclosure solves this problem by means of a welding apparatus in the form of a welding inverter or a welding controller comprising means for achieving data transmission between the welding apparatus and a further device, said means being designed such that wireless and preferably safe data transmission can be achieved via radio, in particular WLAN.

The costs of cabling between welding apparatus and device can hence be dispensed with.

The means are preferably designed such that wireless data transmission can be achieved by means of a Fieldbus that is commonly used in automation engineering such as, for example, Profibus®, Foundation® Fieldbus or HART®, SERCOS®, in particular also safe protocols that guarantee SIL functional safety.

Wireless data transmission via radio is already specified for many data buses, so the data transmission mechanisms that are already implemented and have hitherto been used in a wired manner can now be used wirelessly. In addition, an option to select a wired transmission path (e.g. Ethernet) could be provided so that the welding inverter can also be used in places where, for instance because of location-related interference, wireless operation is permanently or temporarily impossible. Providing an alternative option to select a wired transmission of the protocols based on Profibus®, Foundation® Fieldbus or HART®, SERCOS® further increases safety.

The disclosure also includes a resistance welding unit comprising a welding inverter as described above and a device, preferably an operating device, said device likewise comprising means that can be used to achieve wireless and preferably safe data transmission with the welding inverter in accordance with the SIL standard.

The user thereby has the facility to communicate and exchange data with the welding inverter irrespective of location. The means are preferably designed such that wireless data transmission can be achieved by means of a Fieldbus that is commonly used in automation engineering such as, for example, Profibus®, Foundation® Fieldbus or HART®, SERCOS®.

The device having the means that additionally provide the option of wired (e.g. Ethernet) and preferably safe data transmission, e.g. in accordance with the SIL standard, is preferably an operating device having display unit or another field device or a welding controller or an industrial PC.

The resistance welding unit preferably additionally comprises a welding gun having welding electrodes, on which gun is provided the device in the form of a sensor for recording field measurement data at the electrodes, or in the form of a data storage medium for identifying the welding gun by means of parameters belonging to and specific to the welding gun.

Direct transmission of measurement values obtained at the weld can hence be guaranteed and taken into account in the welding process.

The disclosure also includes a method for exchanging data between the welding inverter and a device. The data for parameterizing the welding inverter could be transmitted, for example, wirelessly between the welding inverter and a device designed as an operating device. The operating device could be designed to have display and user-input facility, and could process graphically and visualize the data. Additionally or alternatively, data for logging the welding process could be transmitted wirelessly between the welding inverter and a device designed as a sensor. Additionally or alternatively, the data for diagnostic analysis of the welding process could also be transmitted wirelessly between welding inverter and a suitable device.

The wireless data transmission is preferably performed by means of a Fieldbus that is commonly used in automation engineering such as, for example, Profibus®, Foundation® Fieldbus or HART®, SERCOS® and the like.

The advantages already described above also apply to the claimed method.

### BRIEF DESCRIPTION OF THE DRAWINGS

FIG. 1 shows the conventional implementation form.

FIG. 2 shows a direct WLAN access to the welding controller.

FIG. 3 shows a controller having sensor.

### DETAILED DESCRIPTION

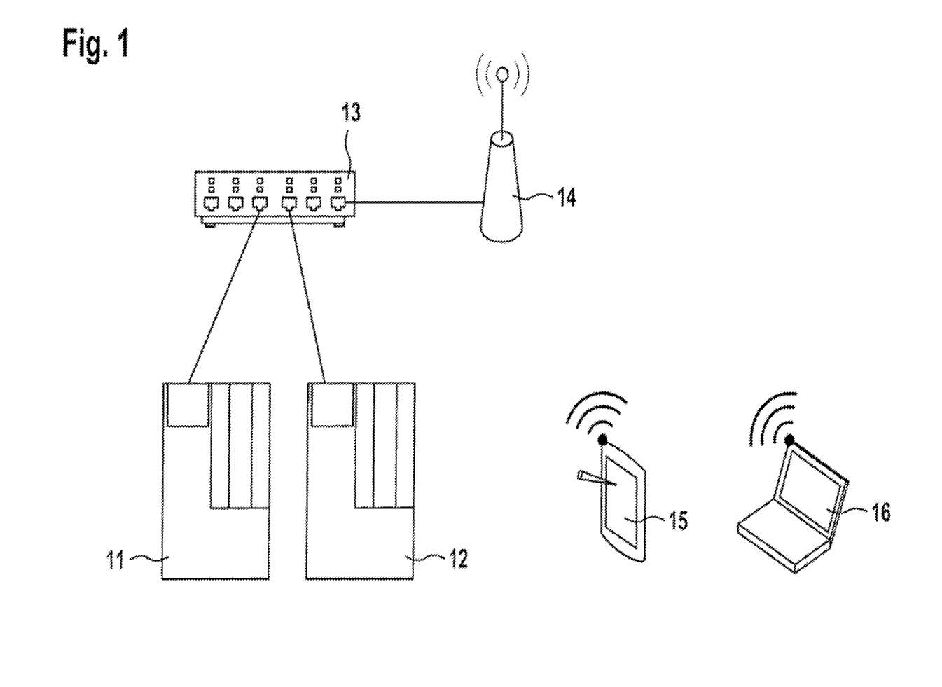

FIG. 1 shows two welding inverters 11, 12, which are connected to a router or switch 13 by means of a wired Ethernet connection. This router or switch 13 is in turn connected to an access point 14, via which it is now possible to wirelessly connect operating devices such as a PC 16 and from the group of smart devices 15 such as mobile phones or tablet PCs.

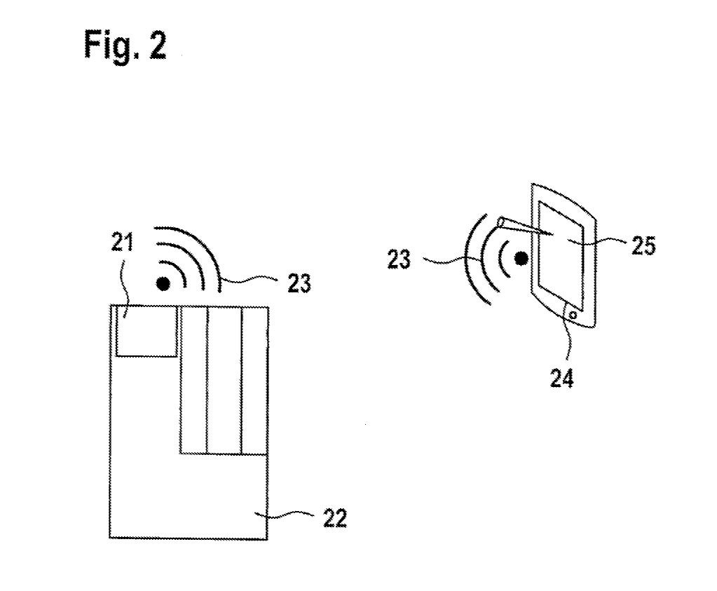

FIG. 2 shows a welding inverter 22 according to the disclosure comprising means 21 for achieving data transmission 23 between the welding inverter 22 and a further device 24, said means 22 being designed such that wireless and preferably safe data transmission can be achieved via radio, for example by means of WLAN.

This achieves a greater degree of freedom in operating the welding inverter 22 and in diagnostic analyses relating to the welding processes performed. The cabling costs can be reduced or even avoided. In addition, at points that are only accessible with difficulty because of wiring harnesses, it is now possible for the user to access the welding inverter 22 easily. Furthermore, a single welding inverter 22 or a series of welding inverters 22 can now be integrated into a production network more easily, for example into a production line for motor vehicles having higher-level controller for the production process. Operating devices are now no longer rigidly tied to a network connection or access point, increasing the operating flexibility during operation of the arrangement.

In addition to pure operation and diagnostic analysis, it is now also possible to perform parameterization wirelessly using one operating device 24 or even a plurality of operating devices 24. The operating device can be used in the immediate environment of the production position at which the welding inverter 22 is normally also arranged, for example in the immediate vicinity of a robot or welding gun. This can dispense with the walk to a central line-PC, for example to adjust welding parameters while the process is running This saves time and costs.

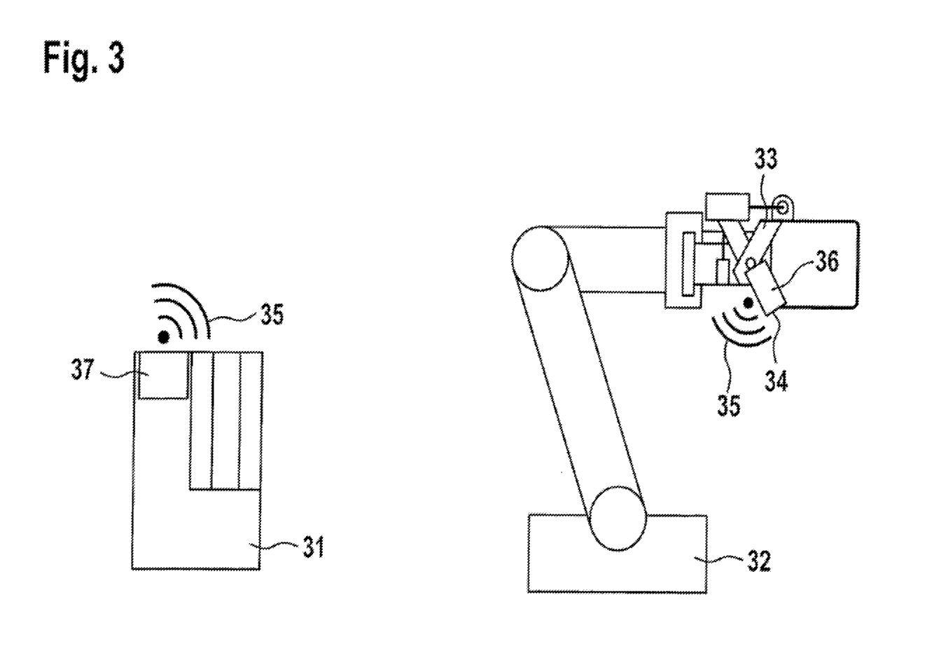

FIG. 3 shows a resistance welding unit comprising a welding inverter 31 according to the disclosure, a welding robot 32 having welding gun 33 and having device 34 in the form of a sensor or memory. The sensor 34 comprises means 35 for achieving wireless data transmission between the welding inverter 31 and the sensor 34, said means preferably being a WLAN module.

The disclosure thus enables the connection of field devices 34 to a welding controller 31 or a welding inverter 31, such as, for instance, to a gun data storage device or data logging units. Hence the disclosure ensures that field devices 34 can be accessed. Thanks to the disclosure, such field devices 34 can now be arranged immediately in the vicinity of the work process to be performed, such as, for instance, in the vicinity of a weld to be made.

Overall, the disclosure ensures simplified handling and the linking of field measurement values or data to a welding inverter 31. Manual programming devices, which were normally fixed to a welding inverter or a welding controller, can now be implemented on the basis of tablet PCs or smart devices that can be carried with the operator.

What is claimed is:

1. A welding apparatus, comprising:
a first device configured to achieve data transmission between the welding apparatus and a remote device, the first device being configured such that the data transmission is configured to be achieved wirelessly via a radio link.

2. The welding apparatus according to claim 1, wherein the first device is configured such that the data transmission is configured to be achieved by a Fieldbus protocol.

3. The welding apparatus according to claim 1, wherein safe protocols are configured to be selected for the data transmission, the safe protocols being configured to guarantee the functional safety of the welding apparatus.

4. The welding apparatus according to claim 1, further comprising a selection device configured to enable selection of wired data transmission by a Fieldbus protocol as an alternative to the radio link.

5. A resistance welding unit, comprising:
a device; and
a welding apparatus including a first device configured to achieve data transmission between the welding apparatus and the device, the first device being configured such that the data transmission is configured to be achieved wirelessly via a radio link,
wherein the device includes a second device configured to achieve wireless data transmission with the first device of the welding apparatus.

6. The resistance welding unit according to claim 5, wherein the second device is configured such that wireless data transmission is configured to be achieved by a Fieldbus protocol.

7. The resistance welding unit according to claim 5, further comprising a selection device on the device, the selection device being configured to enable selection of wired data transmission by a Fieldbus protocol as an alternative to the radio link.

8. The resistance welding unit according to claim 5, further comprising a welding gun having welding electrodes, the device being configured on the welding gun in the form of (i) a sensor configured to record field measurement data at the electrodes or (ii) a data storage medium configured to identify the welding gun by parameters belong to and specific to the welding gun.

9. The resistance welding unit according to claim 5, wherein the device is configured as one or more of an operating device having a display unit, a field device, a resistance welding unit component, and an industrial PC.

10. A method for exchanging data between a welding apparatus having a first device configured to achieve wireless data transmission via a radio link and a device having a second device configured to achieve wireless data transmission via a radio link, the method comprising:
achieving wireless data transmission between the welding apparatus and the device so as to exchange data for parameterizing the welding apparatus.

11. The method according to claim 10, wherein data for logging a welding process performed by the welding apparatus is exchanged by the device.

12. The method according to claim 10, wherein data for diagnostic analysis of a welding process performed by the welding apparatus is exchanged by the device.

13. The method according to claim 10, wherein the exchanged data is processed by the device and is visualized by a display unit of the device.

14. The method according to claim 10, wherein the wireless data transmission is performed by a Fieldbus protocol.

15. The welding apparatus according to claim 1, wherein the welding apparatus is configured as a welding inverter or welding controller, and wherein the data transmission is configured to be achieved safely via the radio link.

16. The welding apparatus according to claim 2, wherein the Fieldbus protocol is configured as one or more of Profibus®, Foundation® Fieldbus, HART®, and SERCOS®.

17. The welding apparatus according to claim 4, wherein the wired data transmission is configured to be safe, and wherein the Fieldbus protocol is configured as one or more of Profibus®, Foundation® Fieldbus, HART®, and SERCOS®.

18. The resistance welding unit according to claim 6, wherein the Fieldbus protocol is configured as one or more of Profibus®, Foundation® Fieldbus, HART®, and SERCOS®.

19. The resistance welding unit according to claim 7, wherein the wired data transmission is configured to be safe, and wherein the Fieldbus protocol is configured as one or more of Profibus®, Foundation® Fieldbus, HART®, and SERCOS®.

20. The method according to claim 14, wherein the Fieldbus protocol is configured as one or more of Profibus®, Foundation® Fieldbus, HART®, and SERCOS®.
